(19) United States
(12) Patent Application Publication
(10) Pub. No.: US 2005/0180316 A1
(43) Pub. Date: Aug. 18, 2005

(54) Protection for bi-directional optical wavelength division multiplexed communications networks

(76) Inventor: Frederick Ying-shu Chan, Kowloon (HK)

Correspondence Address: STITES & HARBISON PLLC, 1199 NORTH FAIRFAX STREET, SUITE 900, ALEXANDRIA, VA, 22314, US

(21) Appl. No.: 10/776,232

(22) Filed: Feb. 12, 2004

(51) Int. Cl. H04L 12/26

(52) U.S. Cl. 370/216

(57) ABSTRACT

A bi-directional wavelength division multiplexed (WDM) optical communications network that includes components for automatically detecting a fault along a primary optical waveguide in a link forming part of a bi-directional WDM communication network and switching the transmission path of the optical signals propagated along that link from that waveguide to a second standby waveguide whenever a fault is detected in the first waveguide using 1×2 optical switches, optical filters, photodetectors and electronics in a configuration designed to avoid silent event failures. Replacing the 1×2 optical switches with 2×2 optical switches in conjunction with other equipment can allow either the constant monitoring of the standby waveguide, provide back up for optical transmitters, receivers and couplers on the path containing the primary waveguide and/or allow carriage of low priority traffic on the standby waveguide as long as it is in standby mode. No handshaking mechanism is required between the opposite ends of the waveguides for the switchover protection.

### FIELD OF THE INVENTION

The present invention relates to optical communications networks in general and, more particularly, to bi-directional optical communications networks in which two wavelength division multiplexed (WDM) optical signals propagate in opposite directions on a bi-directional waveguide. Following a waveguide failure (such as a fiber optic cable cut or other equipment failure), optical traffic is re-routed by a switching protection mechanism to a second bi-directional waveguide in order to avoid an interruption in the propagation of the optical signals.

### BACKGROUND OF THE INVENTION

Optical communication transmission systems operate at high speeds and carry large volumes of traffic of various kinds. Presently, fiber optic cable and related regeneration/amplification equipment constitute the transmission medium commonly employed in such systems. Since optical fiber link failures are not uncommon for such systems, a fault recovery system that is fast (on the order of tens of milliseconds) and reliable is needed. Using standby fiber links and protection switches to perform Automatic Protection Switching (APS) is usually the first line of defense against such failures as described in Wu, T., “Fiber Network Service Survivability”. Norwood, Mass.: Artech House, 1992.

In APS systems, failures are circumvented by re-routing signals from a working fiber to a standby fiber, using protection switches at the ends of each network link, which are activated immediately when a fault is detected. The interconnections between protection switches are updated according to strategies that are designed when network links are configured. The whole system forms a detour around faults to maintain signal flow. Since protection switching is performed at individual switching nodes without instructions from a central manager, APS is distributed and autonomous.

At present, dedicated point-to-point APS systems are known to be unidirectional while APS in ring networks are “bi-directional” in the sense that there are dual unidirectional rings, carrying counter-propagating traffic respectively. Both types of systems require a total of 4 fibers (2 working and 2 for protection) between each node pair in a network to establish two-way communication with switching protection. In other words, none of the fiber links operates in a true duplex state. See U.S. Pat. Nos. 5,717,796, 5,926,102, 6,321,004 and 6,266,168.

In Technical Practice Document No. 522-900-001-104, “FiberMultiplier Protected Bidirectional Systems”, Fitel-PMX introduces the concept of truly bi-directional system protection at the optical layer. This prior art also explains the difficulties of bi-directional link protection, caused by a loopback silent failure that prevents restoration of the transmission path by switching to a secondary fiber link.

Thus, there is a need in the art for truly bi-directional system protection at the optical layer that is not vulnerable to loopback silent failures.

### SUMMARY OF THE INVENTION

It is an object of the present invention to detect a fault along a primary optical waveguide forming a link in a bi-directional WDM communication network and to switch the transmission path of the optical signals propagated along that link from the that waveguide to a second standby waveguide whenever a fault is detected in the first waveguide.

According to one aspect of the invention, it provides a bi-directional WDM optical communications network having a protection switching capability within two bi-directional optical waveguides, wherein the transmission scheme can accommodate one or more optical signals at distinct wavelengths or bands of wavelengths, each of which can accommodates one or more channels, comprising: (a) two node disjoint bi-directional optical waveguides, each of which is configured to carry one or more of the counterpropagating WDM optical communications signals; (b) optical signal transmitting means, at each end of the network, for transmitting one or more of the WDM optical communications signals having distinct wavelengths or bands of wavelengths; (c) optical signal receiving means, at each end of the network, for receiving one or more WDM optical communications signals having distinct wavelengths or bands of wavelengths other than the wavelengths or bands of wavelengths of the signals sent by the transmitting means located at the same end of the network as said receiving means; (d) coupling means, at each end of the network, for adding the optical signals of the transmitting means at that end of the network to the waveguide and removing the optical signals received at the same end of the network from the waveguide; and (e) waveguide failure detection means, connected to the coupling means at each end of the two bi-directional optical waveguides, for detecting a failure of one of the waveguides and switching the transmission path of bi-directional optical signals from the failed waveguide to the other waveguide, said detection means comprising: (i) a 1×2 optical switch capable of switching one end of the transmission path of one or more optical signals from one bi-directional optical waveguide to the other waveguide; (ii) two optical splitters, one connected to each of the two bi-directional optical waveguides, for tapping optical power received from the optical signals sent by the transmitting means located at the opposite end of the respective waveguide; (iii) an optical filter connected to each splitter that rejects signals of the wavelengths or bands of wavelength transmitted by the transmitter located at the same end of the bi-directional optical waveguides as the filter and accepts signals of the wavelengths or bands of wavelengths transmitted by the transmitter located at the opposite end of the bi-directional optical waveguides; (iv) optical means, connected to each filter, for detecting a drop in the optical power of the optical signals received from the transmitter at the opposite end of the bi-directional optical waveguides; and (v) control electronics for switching one end of the transmission path of the bi-directional optical signals from one bi-directional optical waveguide to the other when an optical power drop is detected in the bi-directional optical signals transmitted along the first bi-directional optical waveguide by the detection means.

According to another aspect of the invention, it provides for the use of 2×2 optical switches instead of 1×2 optical switches.

### BRIEF DESCRIPTION OF THE DRAWINGS

The invention will now be described in more detail with reference to the accompanying drawings, in which:

FIG. 1A depicts a bi-directional WDM optical communications network according to one embodiment of the present invention that includes components for automatically detecting a fault along a primary optical waveguide forming a link in a bi-directional WDM communication network and switching the transmission path of the optical signals propagated along that link from the first waveguide to a second standby waveguide whenever a fault is detected in the first waveguide using 1×2 optical switches;

FIG. 1B depicts the embodiment of the invention shown in FIG. 1A wherein there is a fault in the primary optical waveguide; and

FIG. 2 depicts a bi-directional WDM optical communications network according to another embodiment of the present invention that includes components for automatically detecting a fault along a primary optical waveguide forming a link in a bi-directional WDM communication network and switching the transmission path of the optical signals propagated along that link from the first waveguide to a second standby waveguide whenever a fault is detected in the first waveguide using 2×2 optical switches.

### DETAILED DESCRIPTION OF THE INVENTION

The present invention is a kind of APS implementation focused on bi-directional optical transmission systems. The network protected in such a way is able to recognize and respond to fault conditions as soon as they occur. While the discussion is focused on all optical networks, it applies, more generally, to networks incorporating any type of switching, transmission and other communications technology and signal multiplexing scheme, protocol or technology.

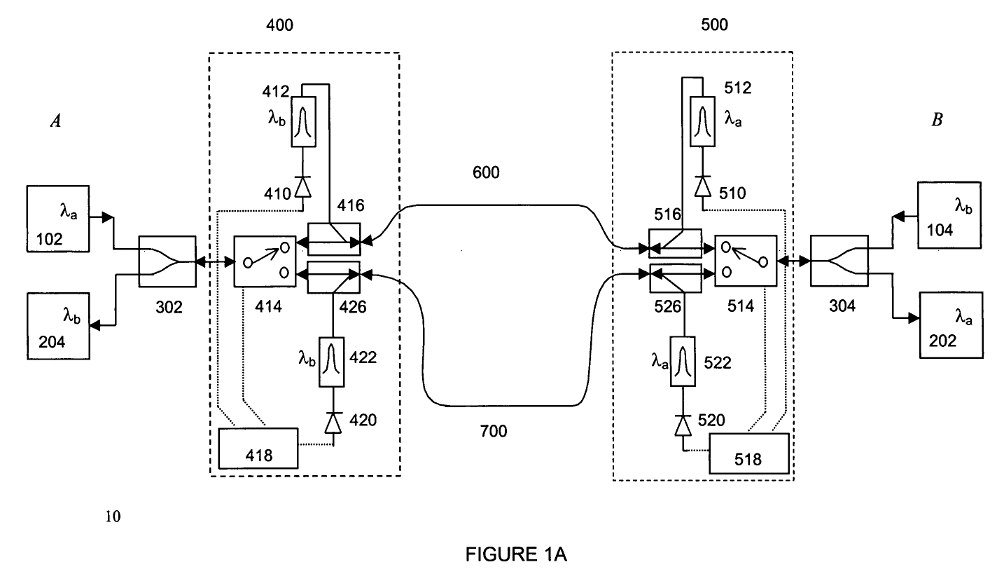

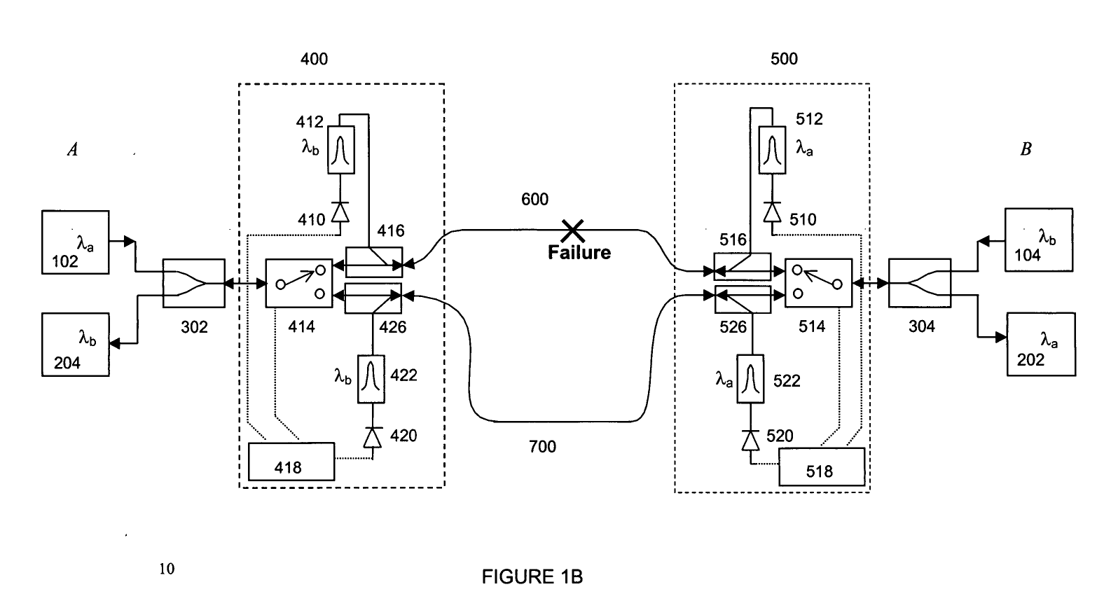

Turning to the drawings in detail, FIG. 1A depicts a bi-directional WDM optical communications network 10 according to one embodiment of the invention. The bi-directional WDM optical network includes two bi-directional waveguides 600 and 700, each of which is configured to carry counter-propagating WDM optical communications signals, each comprising plural optical channels at different channel wavelengths. In accordance with traditional industry nomenclature, the WDM signals propagating in a first direction and having a distinct carrier wavelength or band of wavelengths λₐ is designated as the west-east WDM signals and the WDM signals propagating in the opposite direction and having a distinct carrier wavelength or band of wavelengths λ_{b} is designated as the east-west WDM signals. As used herein the expression “WDM” refers to any optical system or signal composed of plural optical channels having different wavelengths, regardless of the number of channels in the system or signal. Some other examples are, without limitation, DWDM (Dense Wavelength Division Multiplexing) and CWDM (Coarse Wavelength Division Multiplexing). Any medium capable of carrying an optical signal and related equipment along that path may be used as a waveguide 600 or 700.

It is noted that although the bi-directional optical network 10 of FIG. 1A is depicted as a two-node point-to-point network, the present invention may be employed using various configurations of pairs of bi-directional waveguides, each of which carries counter-propagating WDM optical signals including plural channels. Examples of other topologies include mesh networks, ring networks, subtended ring networks, or other network topologies having at least one pair of bi-directional optical waveguides. The term “optical network” as used herein, describes any system that that includes at least two optical signal transmitters 102 and 104 each operating at a distinct wavelength or wavelength band, λₐ or λ_{b}, two optical signal receivers 202 and 204 each operating at the corresponding distinct wavelength or wavelength band of transmitters 102 and 104 respectively, two optical waveguides 600 and 700, two couplers (i.e., WDM couplers or any technology that adds or drops signals of specific wavelengths or bands of wavelength) 302 and 304 and two sets of equipment 400 and 500 necessary to detect a failure of an optical waveguide and switch the bi-directional traffic to another optical waveguide. Such a network may carry various types of information traffic, including, but not limited to, audio, video, data and voice traffic encoded on optical channels.

FIG. 1B depicts the bi-directional WDM optical communications network 10 as in FIG. 1A according to the same embodiment of the invention when bi-directional optical waveguide 600 is disrupted (e.g., a fiber cut).

The protection scheme employs dedicated resources that support fast recovery time. The key processes are fault monitoring and switching execution, which are carried out through the integration of photodetectors, optical filters, electronics and optical switches. These facilities are installed at both ends of the optical waveguides responsible for propagating bi-directional traffic. The scheme makes use of a redundant link-disjoint single bi-directional waveguide to serve as a backup medium for transmission when the primary waveguide fails.

To allow bi-directional optical signals propagating in a single fiber, coupler 302 is used to add the signal of wavelength or wavelength band λₐ to the waveguide 600 and drop the signal of wavelength or wavelength band λ_{b} from it and coupler 304 is used to add the signal of wavelength or wavelength band λ_{b} to the waveguide 600 and drop the signal of wavelength or wavelength band λₐ from it. The bandwidth of the coupler filter will influence the number of channels allowed and thus the overall traffic capacity of the optical path.

The present invention adopts the low cost and simple method of optical power measurement for fault monitoring. A sufficient loss of incident power is often very likely to be a sign of a fault occurring along the optical path (e.g., a cable cut or optical amplifier/regenerator break down or a transmitter failure). Typically, an optical path is considered out-of-service when power is dropped to 6 dB (i.e., 75%) below the initial recorded level during setup to accommodate the dynamic number of channels in the WDM network. However, networks demanding a higher quality of service may further reduce this threshold. Accordingly, a small portion of the optical signal power of each of the east-west and west-east optical signal is tapped by splitters 416 and 516, respectively and allowed to pass by matching optical or narrowband filters 412 and 512 through to photodetectors 410 and 510, to allow passage of λ_{b} and λₐ, respectively. Splitters 416 and 516 typically have high splitting ratios. For example, 1:99 is not uncommon, and in such cases 1% of the incoming optical power would go to the photodetectors 410 and 510, while 99% would go to the optical switches 414 and 514, respectively. When there is a disruption in waveguide 600, the signal power detected by detectors 410 and 510 will fall to levels low enough to cause the control electronics 418 and 518 to operate the optical switches 414 and 514, respectively, thereby switching the propagation path of the bi-directional signal from waveguide 600 to standby waveguide 700. The switching execution process commences as soon as a path failure is spotted. Accordingly, communication disruption lasts only for a fraction of a second (e.g., in the order of a few milliseconds) before the second waveguide assumes propagation of the live traffic from the faulty waveguide. No handshaking or additional protocol communications are required between equipment 400 and 500 for switchover to occur.

Though protection facilities are deployed on both sides of the waveguides 600 and 700, the protection facilities at each transmitting end are transparent to the signal going out from each corresponding transmitter. The true protection procedure only takes place, if required, at each receiving end of the network.

Normally, a path failure will cause the signal transmitted on either side of the fault to be reflected back to the source and amplified resulting in significant near-end crosstalk. In the absence of any filtering of this crosstalk, there may not be a sufficient decrease in the overall signal power levels measured by detectors 410 and 510 to cause the control electronics 418 and 518 to operate the optical switches so as to transfer the live traffic from waveguide 600 to waveguide 700, thereby leading to a “silent failure” event (i.e., a fault that is not detected and corrected). The matching optical filters 412 and 512 in front of detectors 410 and 510, respectively are responsible for eliminating the effect of the reflected local signals so that the waveguide status is always correctly detected and appropriate corrective action is taken in the case of a fault. Each filter, 412 and 512, has a large isolation effect (e.g., 25 dB) on the wavelengths or wavelength bands λₐ and λ_{b}, to be rejected respectively, but negligible insertion loss on wavelengths or or wavelength bands λ_{b} and λₐ, to be passed on to the corresponding detectors, 410 and 510, respectively.

The overall 1×2 parallel design of the protection facility imposes no fixed requirement on path configuration and additionally allows role swapping of the connected paths at any time. In other words, waveguide 700 can be used as the primary transmission path, while waveguide 600 in the backup. In such a case, splitters 426 and 526, optical detectors 420 and 520, and optical filters 422 and 522, would operate in the same manner as the corresponding components described above along with control electronics 418 and 518 and optical switches 414 and 514 to switch traffic from waveguide 700 to waveguide 600 in the event of a disruption in waveguide 700.

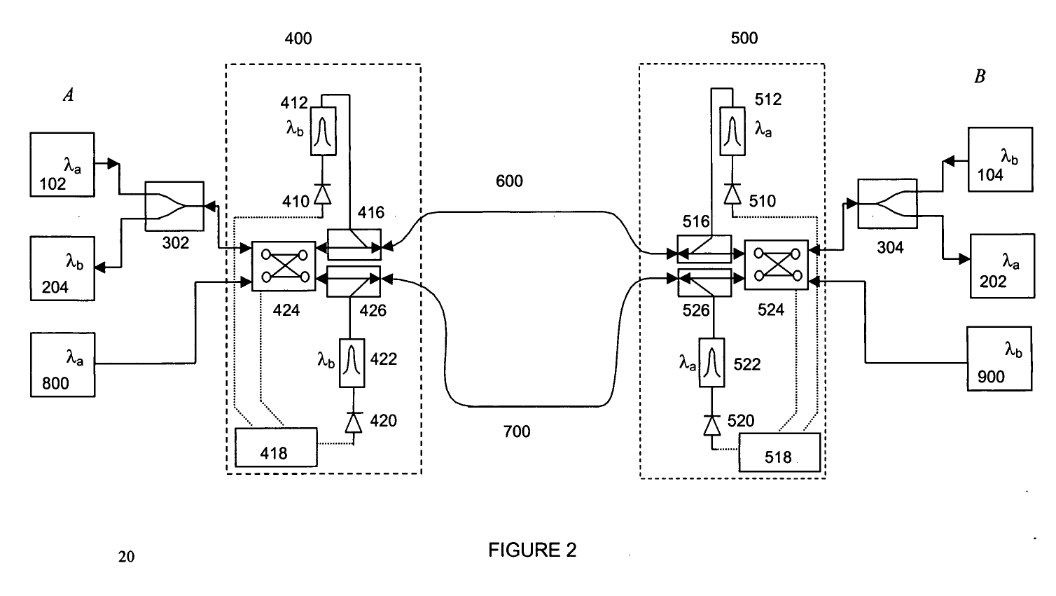

FIG. 2 illustrates another embodiment of the invention 20 according to which 1×2 optical protection switches 414 and 514 from FIG. 1B are replaced with 2×2 protection switches 424 and 524 and, optionally, additional equipment, collectively 800 (such as dummy lasers, a duplicate of optical transmitter 102, optical receiver 204 and/or coupler 302) and 900 (such as dummy lasers, a duplicate of optical transmitter 104, optical receiver 202 and/or coupler 304), respectively to allow either the constant monitoring of the standby waveguide 700, provide back up for the optical transmitters 102 and 104, optical receivers 204 and 202 and couplers 302 and 304 and/or allow carriage of low priority traffic on the standby waveguide 700 as long as it is in standby mode. In all other respects the embodiment of the invention in FIG. 2 is the same as that set out in FIG. 1A.

It is to be understood that the embodiments and variations shown and described herein are merely illustrations of the principles of this invention and that various modifications may be implemented by those skilled in the art without departing from the spirit and scope of the invention.

1. A bi-directional wavelength division multiplexed (WDM) optical communications network having a protection switching capability within two bi-directional optical waveguides, wherein the transmission scheme can accommodate one or more optical signals at distinct wavelengths or bands of wavelengths, each of which can accommodates one or more channels, comprising:
a) two node disjoint bi-directional optical waveguides, each of which is configured to carry one or more of the counterpropagating WDM optical communications signals;
b) optical signal transmitting means, at each end of the network, for transmitting one or more of the WDM optical communications signals having distinct wavelengths or bands of wavelengths;
c) optical signal receiving means, at each end of the network, for receiving one or more WDM optical communications signals having distinct wavelengths or bands of wavelengths other than the wavelengths or bands of wavelengths of the signals sent by the transmitting means located at the same end of the network as said receiving means;
d) coupling means, at each end of the network, for adding the optical signals of the transmitting means at that end of the network to the waveguide and removing the optical signals received at the same end of the network from the waveguide;
e) waveguide failure detection means, connected to the coupling means at each end of the two bi-directional optical waveguides, for detecting a failure of one of the waveguides and switching the transmission path of bi-directional optical signals from the failed waveguide to the other waveguide, said detection means comprising:
i) a 1×2 optical switch capable of switching one end of the transmission path of one or more optical signals from one bi-directional optical waveguide to the other waveguide;
ii) two optical splitters, one connected to each of the two bi-directional optical waveguides, for tapping optical power received from the optical signals sent by the transmitting means located at the opposite end of the respective waveguide;
iii) an optical filter connected to each splitter that rejects signals of the wavelengths or bands of wavelength transmitted by the transmitter located at the same end of the bi-directional optical waveguides as the filter and accepts signals of the wavelengths or bands of wavelengths transmitted by the transmitter located at the opposite end of the bi-directional optical waveguides;
iv) optical means, connected to each filter, for detecting a drop in the optical power of the optical signals received from the transmitter at the opposite end of the bi-directional optical waveguides; and
v) control electronics for switching one end of the transmission path of the bi-directional optical signals from one bi-directional optical waveguide to the other when an optical power drop is detected in the bi-directional optical signals transmitted along the first bi-directional optical waveguide by the detection means.

2. A bi-directional communications network as in claim 1 having a protection switching capability within two bi-directional waveguides wherein said network employs any switching, transmission and other communications technology and signal multiplexing scheme, protocol or technology.

3. A bi-directional WDM optical communications network having a protection switching capability within two bi-directional optical waveguides as in claim 1, incorporating any network topology.

4. A bi-directional communications network having a protection switching capability within two bi-directional waveguides as in claim 2, incorporating any network topology.

5. A bi-directional WDM optical communications network having a protection switching capability within two bi-directional optical waveguides as in claim 1, wherein an optical path is considered out of service when the received optical signal power measured by the optical detection means is more than 2 dB below the level recorded when the equipment is initially set up.

6. A bi-directional WDM optical communications network having a protection switching capability within two bi-directional optical waveguides as in claim 1, wherein each optical splitter taps no less than 1% of the optical power received from the far end of the optical waveguide.

7. A bi-directional WDM optical communications network having a protection switching capability within two bi-directional optical waveguides as in claim 1, wherein each optical filter has an isolation effect of at least 4 dB on the wavelength to be rejected.

8. A bi-directional wavelength division multiplexed (WDM) optical communications network having a protection switching capability within two bi-directional optical waveguides, wherein the transmission scheme can accommodate one or more optical signals at distinct wavelengths or bands of wavelengths, each of which can accommodates one or more channels, comprising:
a) two node disjoint bi-directional optical waveguides, each of which is configured to carry one or more of the counterpropagating WDM optical communications signals;
b) optical signal transmitting means, at each end of the network, for transmitting one or more of the WDM optical communications signals having distinct wavelengths or bands of wavelengths;
c) optical signal receiving means, at each end of the network, for receiving one or more WDM optical communications signals having distinct wavelengths or bands of wavelengths other than the wavelengths or bands of wavelengths of the signals sent by the transmitting means located at the same end of the network as said receiving means;
d) coupling means, at each end of the network, for adding the optical signals of the transmitting means at that end of the network to the waveguide and removing the optical signals received at the same end of the network from the waveguide;
e) waveguide failure detection means, connected to the coupling means at each end of the two bi-directional optical waveguides, for detecting a failure of one of the waveguides and switching the transmission path of bi-directional optical signals from the failed waveguide to the other waveguide, said detection means comprising:
i) a 2×2 optical switch capable of switching one end of the transmission path of an optical signal from one bi-directional optical waveguide to the other waveguide;
ii) two optical splitters, one connected to each of the two bi-directional optical waveguides, for tapping optical power received from the optical signals sent by the transmitting means located at the opposite end of the respective waveguide;
iii) an optical filter connected to each splitter that rejects signals of the wavelengths or bands of wavelength transmitted by the transmitter located at the same end of the bi-directional optical waveguides as the filter and accepts signals of the wavelengths or bands of wavelengths transmitted by the transmitter located at the opposite end of the bi-directional optical waveguides;
iv) optical means, connected to each filter, for detecting a drop in the optical power of the optical signals received from the transmitter at the opposite end of the bi-directional optical waveguides; and
v) control electronics for switching one end of the transmission path of the bi-directional optical signals from one bi-directional optical waveguide to the other when an optical power drop is detected in the bi-directional optical signals transmitted along the first bi-directional optical waveguide by the detection means.
f) additional equipment from the group of equipment comprising dummy lasers, optical transmitters, optical receivers, optical couplers connected to each 2×2 switch to enable either the constant monitoring of the second standby waveguide, provide back up for the optical transmitters, optical receivers and optical couplers connected to the primary waveguide through the switch and/or enable carriage of low priority traffic on the second standby waveguide as long as it is in standby mode.

9. A bi-directional communications network as in claim 8 having a protection switching capability within two bi-directional waveguides wherein said network employs any switching, transmission and other communications technology and signal multiplexing scheme, protocol or technology.

10. A bi-directional WDM optical communications network having a protection switching capability within two bi-directional optical waveguides as in claim 9, incorporating any network topology.

11. A bi-directional communications network having a protection switching capability within two bi-directional waveguides as in claim 8, incorporating any network topology.

12. A bi-directional WDM optical communications network having a protection switching capability within two bi-directional optical waveguides as in claim 8, wherein an optical path is considered out of service when the received optical signal power measured by the optical detection means is more than 2 dB below the level recorded when the equipment is initially set up.

13. A bi-directional WDM optical communications network having a protection switching capability within two bi-directional optical waveguides as in claim 8, wherein each optical splitter taps no less than 1% of the optical power received from the far end of the optical waveguide.

14. A bi-directional WDM optical communications network having a protection switching capability within two bi-directional optical waveguides as in claim 8, wherein each optical filter has an isolation effect of at least 4 dB on the wavelength to be rejected.
